(19) United States
(12) Patent Application Publication
(10) Pub. No.: US 2017/0051869 A1
(43) Pub. Date: Feb. 23, 2017

(54) Lifting Holder Structure

(71) Applicant: Chern Shing Top Co., Ltd., Zhuqi Township (TW)

(72) Inventor: Hsueh-Sheng Hsiao, Zhuqi Township (TW)

(21) Appl. No.: 14/832,161

(22) Filed: Aug. 21, 2015

(51) Int. Cl. F16M 11/26; A47B 9/04

(52) U.S. Cl. CPC F16M 11/26; A47B 9/04; A47B 2009/043; A47B 2200/002

(57) ABSTRACT

A lifting holder structure contains a base and a moving rod, and the base includes plural fitting sleeves which are fitted together, the moving rod includes a first screwing post arranged on a bottom end thereof and fitted into a second screwing post via a lowermost of the plural fitting sleeves. The second screwing post and the plural fitting sleeves are fixed via an interstitial connecting structure, and a top of the second screwing post is limited by a driving post within an angle range and is driven by an angular coupling structure, such that the driving post rotates to drive the second screwing post and a first screwing post to change a pitch stroke, thus moving a lifting holder vertically.

### BACKGROUND OF THE INVENTION

Field of the Invention

The present invention relates to a lifting holder structure contains a base and a moving rod in which a second screwing post is fitted, wherein the second screwing post and plural fitting sleeves are fixed via an interstitial connecting structure, and a top of the second screwing post is limited by a driving post within an angle range and is driven by an angular coupling structure, such that the driving post rotates to drive the second screwing post and a first screwing post to change a pitch stroke, thus moving a lifting holder vertically and swinging the second screwing post smoothly in a predetermined margin.

Description of the Prior Art

A conventional lifting holder lifts and descends objects (such as a desk) based on a desired height, wherein a threaded structure is arranged in the lifting holder to adjust a height of the objects except for the desk.

For example, the lifting holder is fixed on the desk and contains a driving post for driving the threaded structure to change a moving stroke to adjust the desk. The threaded structure contains a threaded post and a screwing post which are screwed together (by using inner threads and outer threads). The threaded structure also includes a base including plural fitting sleeves fitted together. Accordingly, a bottom of the threaded post is disposed on a bottom of the plural fitting sleeves of the base, and the driving post is rotatably connected with a top of the plural fitting sleeves, such that the driving post drives the screwing post to move relative to the threaded post, such that a moving stroke is changed to adjust the height of the lifting holder (the driving post has a driven gear which is driven by a drive gear of a motor or a worm and a worm wheel).

Accordingly, in adjusting process of a height of the desk, the threaded structure changes the height and weight of the desk, and the lifting holder protects the threaded structure, has brilliant appearance, and operates stably. However, a workpiece precision of related components of the lifting holder cannot be controlled well. For instance, a gap produces among the plural fitting sleeves, and the bottom fitting sleeve is not perpendicular to the threaded post (the threaded post is fixed in a welding manner or a locking manner in a working process), so when the threaded post is not vertical to the screwing post, an angular offset occurs to stop operation (with a vertical movement of the base of the threaded structure, the plural fitting sleeves get stuck, and when a nut is screwed with the screwing post, the nut sways relative to the screwing post because of a screwing gap between the nut and the screwing post), thus having troublesome working, high defect rate, and operational inconvenience.

The present invention has arisen to mitigate and/or obviate the afore-described disadvantages.

### SUMMARY OF THE INVENTION

The primary objective of the present invention is to provide a lifting holder structure contains a base and a moving rod, and the base includes plural fitting sleeves which are fitted together, the moving rod includes a first screwing post arranged on a bottom end thereof and fitted into a second screwing post via a lowermost of the plural fitting sleeves. The second screwing post and the plural fitting sleeves are fixed via an interstitial connecting structure, and a top of the second screwing post is limited by a driving post within an angle range and is driven by an angular coupling structure, such that the driving post rotates to drive the second screwing post and a first screwing post to change a pitch stroke, thus moving a lifting holder vertically

Accordingly, a lifting holder structure provided by the present invention contains: a base and a moving rod.

The moving rod includes a first screwing post arranged on a bottom end thereof and fitted into a second screwing post via a lowermost of the plural fitting sleeves, the second screwing post has a hollow fitting section and a threaded section below the hollow fitting section, and a part of the hollow fitting section of the second screwing post is screwed in an uppermost of the plural fitting sleeves of the base, a driving post rotatably connects with a top end of the uppermost fitting sleeve and couples with and drives the hollow fitting section of the second screwing post via an angular coupling structure.

The threaded section of the second screwing post has outer threads for screwing with inner threads defined in the hollow fitting section of the second screwing post, and the threaded section of the second screwing post is rotatably connected with the first screwing post via an interstitial connecting structure, such that the second screwing post moves horizontally to automatically correspond to a driving force of the driving post and a resistance of the first screwing post, thus producing pitch stroke to move a lifting holder.

### BRIEF DESCRIPTION OF THE DRAWINGS

FIG. 1 is a perspective view showing the exploded components of a lifting holder structure according to a preferred embodiment of the present invention.

FIG. 2 is a cross sectional view showing the assembly of the lifting holder structure according to the preferred embodiment of the present invention.

FIG. 3 is a cross sectional view showing the assembly of a part of the lifting holder structure according to the preferred embodiment of the present invention.

FIG. 4 is another cross sectional view showing the assembly of a part of the lifting holder structure according to the preferred embodiment of the present invention.

FIG. 5 is also another cross sectional view showing the assembly of a part of the lifting holder structure according to the preferred embodiment of the present invention.

FIG. 6 is a cross sectional view showing the application of the lifting holder structure according to the preferred embodiment of the present invention.

FIG. 7 is a perspective view showing the application of the lifting holder structure according to the preferred embodiment of the present invention.

FIG. 8 is a perspective view showing the application of a lifting holder structure according to another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

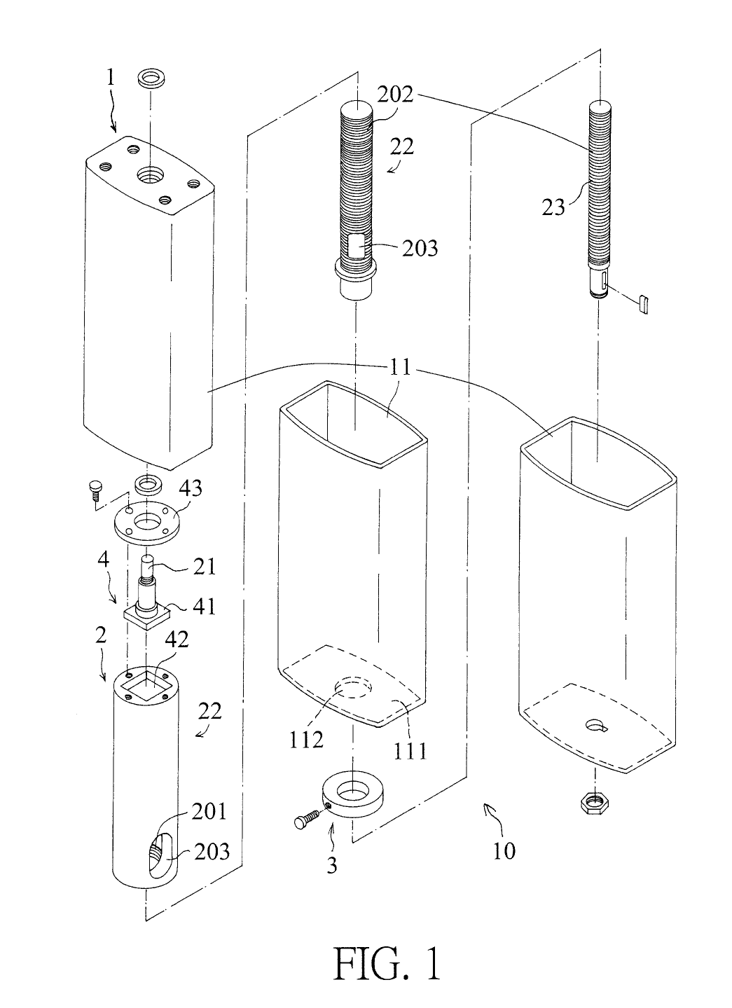

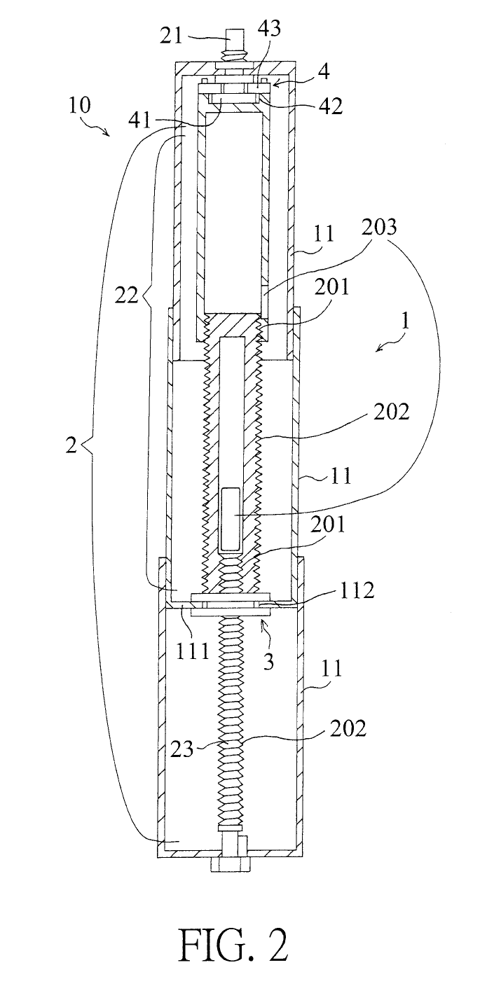

A lifting holder structure according to a preferred embodiment of the present invention comprises: a base 1 and a moving rod 2 (as shown in FIG. 1), wherein the base 1 includes plural fitting sleeves 11 which are fitted together, and the moving rod 2 includes a first screwing post 23 arranged on a bottom end thereof and fitted into a second screwing post 22 via a lowermost of the plural fitting sleeves 11, wherein the second screwing post 22 has a hollow fitting section and a threaded section below the hollow fitting section, wherein a part of the hollow fitting section of the second screwing post 22 is screwed in an uppermost of the plural fitting sleeves 11 of the base 1, and a driving post 21 rotatably connects with a top end of the uppermost fitting sleeve 11 and couples with and drives the hollow fitting section of the second screwing post 22 via an angular coupling structure 4. The threaded section of the second screwing post 22 has outer threads 202 for screwing with inner threads 201 defined in the hollow fitting section of the second screwing post 22 (wherein the hollow fitting section of the second screwing post 22 has a through orifice 203 defined on an outer wall thereof adjacent to a bottom end of the hollow fitting section of the second screwing post 22, such that after the outer threads 202 of the threaded section of the second screwing post 22 screw with inner threads 201 of the hollow fitting section of the second screwing post 22, the through orifice 203 of the hollow fitting section of the second screwing post 22 forces the threaded section of the second screwing post 22 to prevent a removal of the threaded section of the second screwing post 22), and the threaded section of the second screwing post 22 is rotatably connected with the first screwing post 23 via an interstitial connecting structure 3 (as illustrated in FIG. 2).

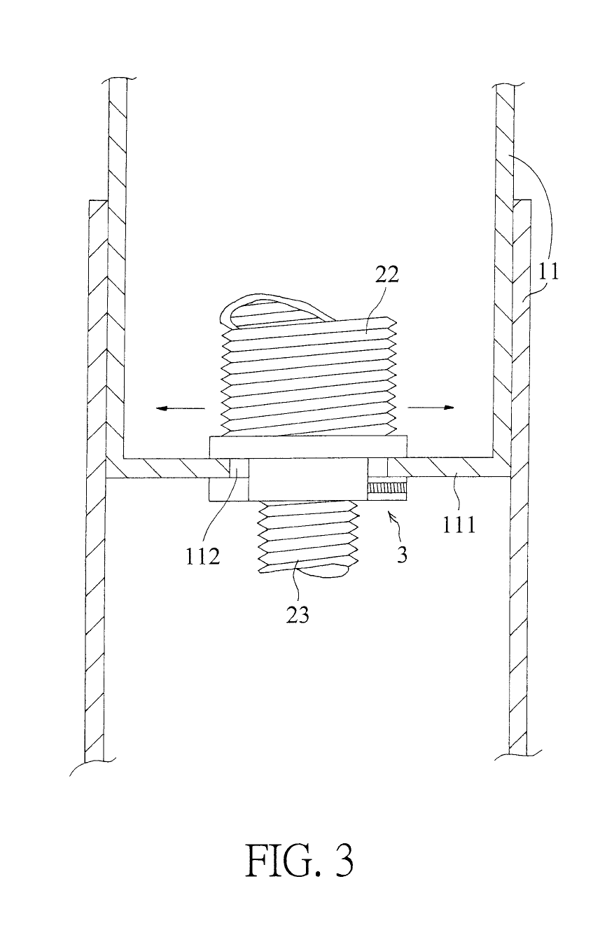

The interstitial connecting structure 3 allows related components of the lifting holder structure to rotatably connect together, to horizontally move, and to tilt vertically and swing in a predetermined margin. In this embodiment, the interstitial connecting structure 3 includes a fixing plate 111 formed on a bottom end of a middle of the plural fitting sleeves 11 and includes a coupling aperture 112 defined on the fixing plate 111 to insert a lower end of the threaded section of the second screwing post 22 (as illustrated in FIG. 3), and after the threaded section of the second screwing post 22 is rotatably connected with the middle fitting sleeve 11, it axially moves along the coupling aperture 112 in the middle fitting sleeve 11.

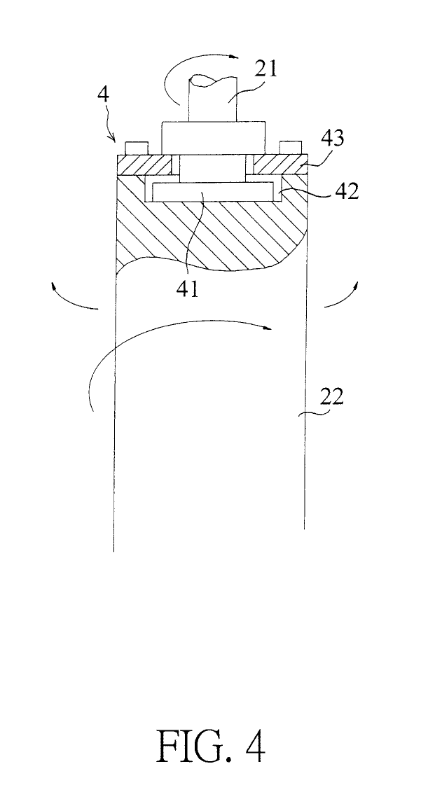

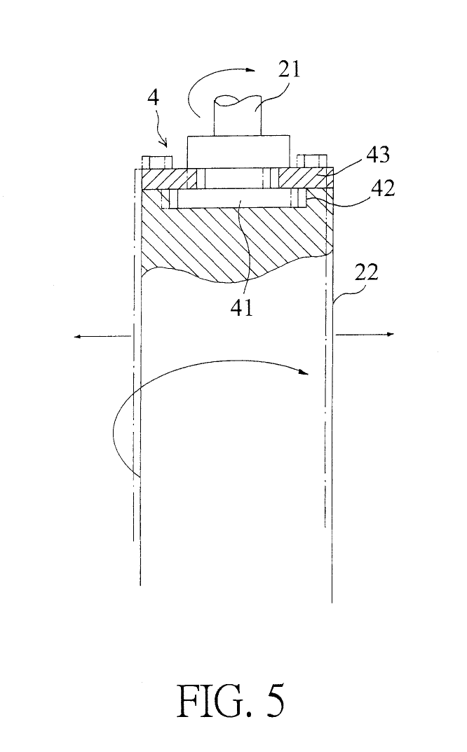

The angular coupling structure 4 allows the related components of the lifting holder structure to horizontally move and to tilt vertically and swing in a predetermined margin and within a limited rotating angle range. In this embodiment, the angular coupling structure 4 includes a noncircular positioning block 41 opposite to the driving post 21, a noncircular groove 42 defined in a top end of the hollow fitting section of the second screwing post 22 (as illustrated in FIGS. 4 and 5), and a cap 43 corresponding to the noncircular groove 42 to limit an axial movement of the positioning block 41 (i.e., the cap 43 limits a rotatable angle of the positioning block 41 relative to the noncircular groove 42 so that the driving post 21 drives the hollow fitting section of the second screwing post 22 smoothly by using the positioning block 41, the noncircular groove 42, and the cap 43), and the noncircular groove 42 provides moveable margin to the positioning block 41 (i.e., a depth of the noncircular groove 42 is greater than a thickness of the positioning block 41).

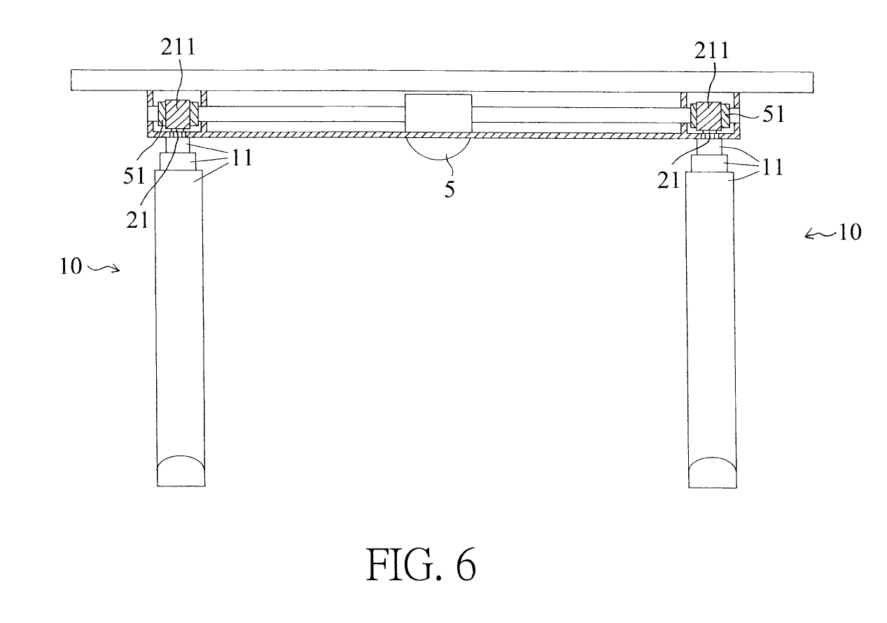

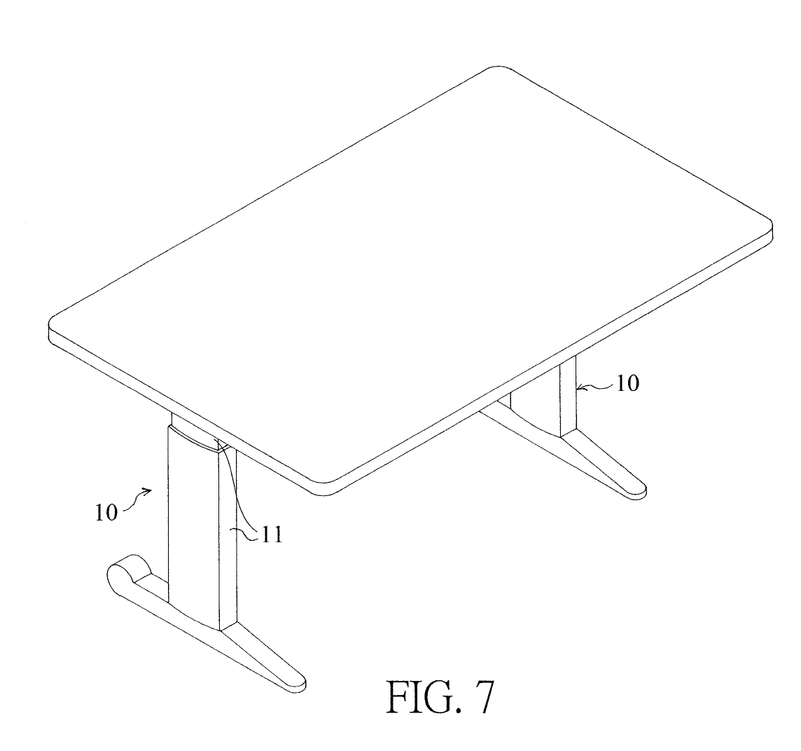

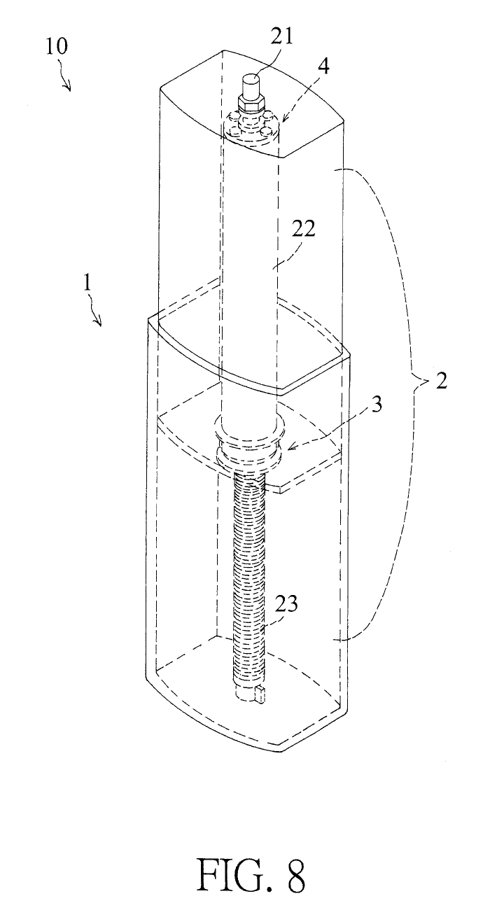

Accordingly, between the threaded section of the second screwing post 22 and the middle fitting sleeve 11 is defined the interstitial connecting structure 3, and when the driving post 21 drives the hollow fitting section of the second screwing post 22 through the angular coupling structure 4 (as shown in FIGS. 6 and 7, the driving post 21 has a driven gear 211 which is driven by any one of a drive gear 51 of a motor 5, a worm and a worm wheel, and a manual operating gear), the second screwing post 22 is driven by the driving post 21 to actuate a vertical movement of the first screwing post 23. Since between the driving post 21 and the middle fitting sleeve 11 is defined the interstitial connecting structure 3, and between the driving post 21 and the second screwing post 22 is defined the angular coupling structure 4, when a concentric error of the driving post 21 and the first screwing post 23 occurs, the second screwing post 22 moves horizontally and swings vertically to automatically correspond to a driving force of the driving post 21 and a resistance of the first screwing post 23, thus offsetting the second screwing post 22 (the second screwing post 22 rotates in a movable gap of the plural fitting sleeves 11 by ways of the interstitial connecting structure 3, and a wearable pad is arranged on a contacting surface of the second screwing post 22 to avoid an abrasion of the second screwing post 22), thus operating a lifting holder 10 smoothly. With reference to FIG. 8, the lifting holder 10 is applicable for two fitting sleeves 11 and three fitting sleeves 11, wherein when the lifting holder 10 is applicable for the three fitting sleeves 11 and the moving rod 2 because each of the first screwing post 23 and the second screwing post 22 has a same pitch, the lifting holder 10 on each of two support legs of a desk lifts or descends the desk to a desired height. When friction resistances between the driving post 21 and the first screwing post 23 produce (due to a threaded stroke of the driving post 21 changes or a threaded stroke between the driving post 21 and the first screwing post 23 changes), positions of the plural fitting sleeves 11 of two bases 1 on two sides of the desk are different, but it does not influence product yield, and the lifting holder 10 operates easily.

While we have shown and described various embodiments in accordance with the present invention, it is clear to those skilled in the art that further embodiments may be made without departing from the scope of the present invention.

What is claimed is:

1. A lifting holder structure comprising: a base and a moving rod, wherein the moving rod includes a first screwing post arranged on a bottom end thereof and fitted into a second screwing post via a lowermost of the plural fitting sleeves, the second screwing post has a hollow fitting section and a threaded section below the hollow fitting section, and a part of the hollow fitting section of the second screwing post is screwed in an uppermost of the plural fitting sleeves of the base, a driving post rotatably connects with a top end of the uppermost fitting sleeve and couples with and drives the hollow fitting section of the second screwing post via an angular coupling structure; the threaded section of the second screwing post has outer threads for screwing with inner threads defined in the hollow fitting section of the second screwing post, and the threaded section of the second screwing post is rotatably connected with the first screwing post via an interstitial connecting structure, such that the second screwing post moves horizontally to automatically correspond to a driving force of the driving post and a resistance of the first screwing post, thus producing pitch stroke to move a lifting holder.

2. The lifting holder structure as claimed in claim 1, wherein the interstitial connecting structure includes a fixing plate formed on a bottom end of a middle of the plural fitting sleeves and includes a coupling aperture defined on the fixing plate to insert a lower end of the threaded section of the second screwing post.

3. The lifting holder structure as claimed in claim 1, wherein the angular coupling structure includes a noncircular positioning block opposite to the driving post, a noncircular groove defined in a top end of the hollow fitting section of the second screwing post, and a cap corresponding to the noncircular groove to limit an axial movement of the positioning block.

4. The lifting holder structure as claimed in claim 1, wherein the interstitial connecting structure and the angular coupling structure allow related components of the lifting holder structure to horizontally move in a predetermined margin, such that the second screwing post tilts vertically and swing to automatically correspond to the driving force of the driving post and the resistance of the first screwing post, thus producing the pitch stroke to move the lifting holder.

5. The lifting holder structure as claimed in claim 2, wherein the interstitial connecting structure and the angular coupling structure allow related components of the lifting holder structure to horizontally move in a predetermined margin, such that the second screwing post tilts vertically and swing to automatically correspond to the driving force of the driving post and the resistance of the first screwing post, thus producing the pitch stroke to move the lifting holder.

6. The lifting holder structure as claimed in claim 3, wherein the interstitial connecting structure and the angular coupling structure allow related components of the lifting holder structure to horizontally move in a predetermined margin, such that the second screwing post tilts vertically and swing to automatically correspond to the driving force of the driving post and the resistance of the first screwing post, thus producing the pitch stroke to move the lifting holder.
